(19) United States
(12) Patent Application Publication
(10) Pub. No.: US 2005/0129388 A1
(43) Pub. Date: Jun. 16, 2005

(54) Computer based image capture system with foot-switch, network support and streaming video

(76) Inventors: James Burns, Purdys, NY (US); Rangarajan Krishnamurthi, Ashland, MA (US)

Correspondence Address: MILDE & HOFFBERG, LLP, 10 BANK STREET, SUITE 460, WHITE PLAINS, NY, 10606, US

(21) Appl. No.: 11/010,925

(22) Filed: Dec. 13, 2004

Related U.S. Application Data
(60) Provisional application No. 60/529,035, filed on Dec. 12, 2003.

(51) Int. Cl. H04N 5/225

(52) U.S. Cl. 386/117

(57) ABSTRACT

A system for displaying an storing still and video images includes a stored program digital computer with an input port for receiving digital images, a display screen, a keyboard and a digital storage medium. The computer is programmed to: (a) capture and selected images and video clips in response to a capture input to the computer by the user. The computer displays such captured images on the display screen. (b) store selected ones of the captured images in association with an identity name input to the computer by the user. (c) create a directory of stored images in accordance with the identity name. (d) export user-selected ones of the stored images into a word processing document template for creating a report.

### CROSS REFERENCE TO RELATED APPLICATION

This application claims priority from Provisional Patent Application Ser. No. 60/529,035, filed Dec. 12, 2003, entitled “SYSTEM FOR CAPTURING AND ANNOTATING STILL AND VIDEO IMAGES FOR MEDICAL REPORTS”, the disclosure of which is incorporated herein by reference.

### BACKGROUND OF THE INVENTION

The medical imaging art includes quite a number of different camera systems and image capture systems. The live video is displayed on a monitor and selected images are captured and stored.

FIG. 1 shows the commonly used setup for endoscopic camera systems.

There are several disadvantages to this prior art approach. They include:
1. Several pieces of equipment are required per surgical suite.
2. The images cannot be easily transferred to the doctor's office for review.
3. The equipment cost is high and not easily affordable by small practices.
4. There is no convenient way of making the images and video available for viewing in the doctor's office after the procedure is complete.
5. It is not easy to make the images and video available on the Hospital/Clinics computer network for preparing reports.
6. There is currently no simple method for capturing images and video and creating reports.
7. Annotation capabilities are very limited in the current systems.
8. The images cannot be easily emailed or used in presentations.
9. Live or captured video cannot be streamed easily over the Internet for telemedicine.

### SUMMARY OF THE INVENTION

The present invention provides an easy to use system that includes support for VFW (Video for windows) and WDM (Windows Device Manager) compatible device drivers to capture from any camera system. System incorporates an easy to use User Interface that has pictures to illustrate actions. The system also includes a foot-pedal to capture images and video directly to an Identity folder. The images can then be reviewed using the system software or Reporter software from any computer on the network. All the images can be captured directly to any location set by the user either on the local drive or a network drive.

### BRIEF DESCRIPTION OF THE DRAWINGS

FIG. 1 is a block diagram showing the system architecture of the prior art.

FIG. 2 is a block diagram of the system according to the present invention.

FIG. 3 is a display screen showing the Graphic User Interface according to the present invention.

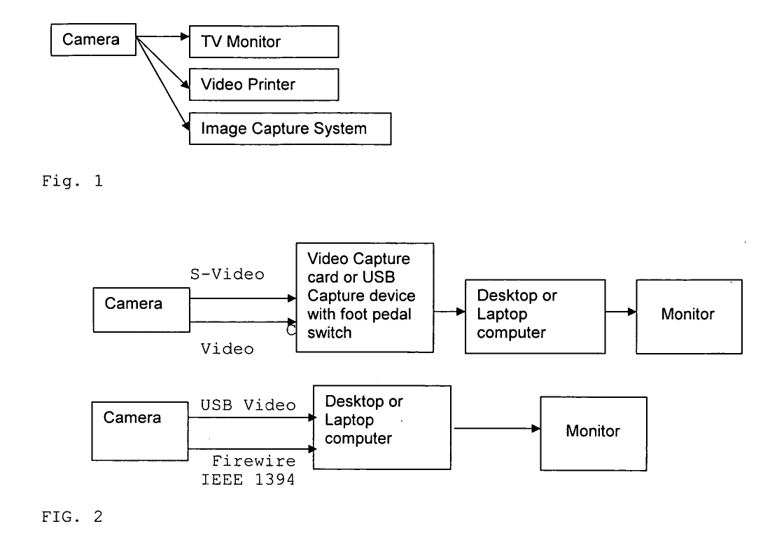

### DESCRIPTION OF THE PREFERRED EMBODIMENTS

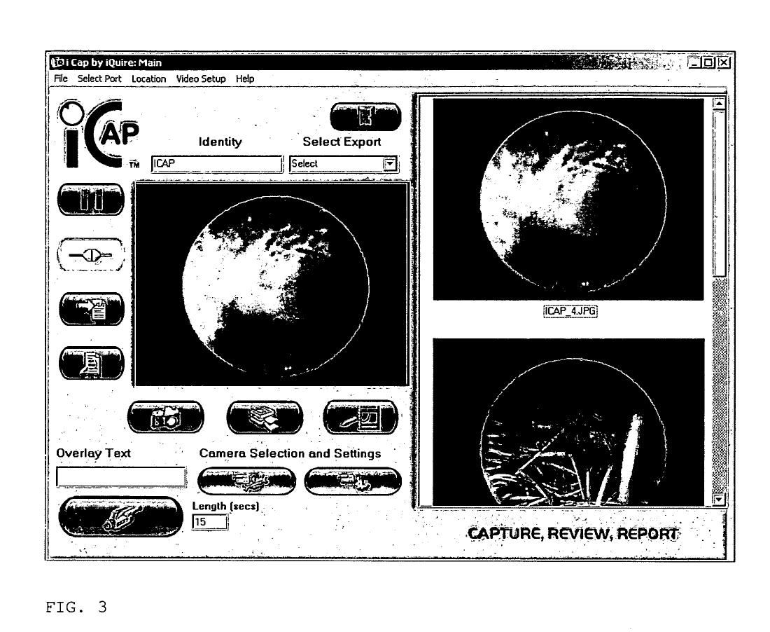

The system according to the present invention will now be described in connection with FIGS. 2 and 3.

The system hardware according to the invention is illustrated in FIG. 2.

The system according to the invention uses WDM or Video for Windows (VFW) image capture capabilities of Microsoft Windows to acquire images from USB Cameras. The software also utilizes Windows support for firewire cameras or custom drivers for image capture boards.

The acquired images are saved on the network at a user selected location/computer on the network. The user can view images and create reports by using the Reporter program from any computer on the network. Images are stored in the Identity folder and catalogued by PatientID_X.jpg or PatientID_X.mpg where X is the image number. This number is sequential and is incremented every time a new image or video is captured. The software automatically finds the largest X and then increments it by one.

Custom Microsoft Word templates are used with the software. The software has an “Export to Word” feature that allows the user to select images and export them to a template of their choice. This makes customization and report generation easy since all of the information required is stored in the templates and the information can be easily entered.

When a Patient ID is entered, the software automatically searches the Identity folder for that Patient ID. Once a match is found, it automatically displays all of the captured images for that Identity. If the Identity does not exist, it creates a new folder for that Identity.

The software uses a Graphical User Interface where actions are indicated by buttons instead of words. The buttons are self-explanatory and the user interface has been designed for simplicity and ease of use. The Graphical User Interface makes it simpler for users in Non-English speaking countries to train on the use of the software and system.

Images and Video can be captured using a foot-pedal that interfaces using the serial port. The software can use the serial interface to respond to button presses on the cameras or endoscopes.

A screen-print of the Graphic User Interface is shown in FIG. 3.

The software used in the system according to the invention includes annotation capabilities; double clicking on the image opens the image for annotation and it is saved after the annotation is complete.

The system, with the software is extremely flexible and easy to use, allowing:
1. Capture of images and video on the customer laptop or computer without the need for expensive equipment.
2. Capture of images and video from any camera system.
3. Live video display on a computer screen.
4. Video and Images to be captured on a computer and stored on the hard drive or other media.
5. Making the images available for viewing on the network.
6. Offering annotation and reporting capabilities.
7. The use of customizable Microsoft Word templates to create reports.
8. Pictures and video to be emailed.
9. Use of images in presentations or documentation.
10. Capture of images and video using a proprietary serial foot pedal during the procedure.

The system according to the invention for capturing images can be applied to other industries where there is a need to provide documentation such as Insurance, Automotive, Repair/Service, Real Estate, Defense, Aviation and other applications.

The attached Appendix is a User Manual which describes the operation of the system.

1. A system for displaying an storing still and video images comprising a stored program digital computer with an input port for receiving digital images, a display screen, a keyboard and a digital storage medium, said computer being programmed to
(a) capture and selected images and video clips in response to a capture input to the computer by the user, said computer displaying such captured images on the display screen;
(b) store selected ones of said captured images in association with an identity name input to the computer by the user;
(c) create a directory of stored images in accordance with the identity name;
(d) export user-selected ones of the stored images into a word processing document template for creating a report.
